(19) United States
(12) Patent Application Publication
(10) Pub. No.: US 2014/0086213 A1
(43) Pub. Date: Mar. 27, 2014

(54) APPARATUS AND METHOD FOR PERFORMING UPLINK SYNCHRONIZATION IN MULTIPLE COMPONENT CARRIER SYSTEM

(71) Applicant: Pantech Co., Ltd., Seoul (KR)

(72) Inventors: Ki Bum Kwon, Seoul (KR); Jae Hyun Ahn, Seoul (KR); Myung Cheul Jung, Seoul (KR)

(73) Assignee: Pantech Co., Ltd., Seoul (KR)

(21) Appl. No.: 14/119,602

(22) PCT Filed: Jun. 8, 2012
(86) PCT No.: PCT/KR2012/004565

§ 371 Date: Nov. 22, 2013

(30) Foreign Application Priority Data
Jun. 10, 2011 (KR) 10-2011-0056052

(51) Int. Cl. H04W 56/00; H04W 74/08; H04W 36/00

(52) U.S. Cl. CPC H04W 56/0005; H04W 36/0055; H04W 74/0833
USPC 370/331

(57) ABSTRACT

An apparatus and method for performing uplink synchronization in a multiple component carrier system are provided. The method includes: receiving a handover command message from a first base station, the handover command message including a timing alignment value for adjusting uplink timing of a secondary serving cell of a second base station; performing handover from the first base station to the second base station based on the handover command message; adjusting the uplink timing of the secondary serving cell of the second base station based on the timing alignment value; and performing a random access through the secondary serving cell of the second base station based on the adjusted uplink timing. According to the present invention, deactivated secondary serving cells of a target base station are rapidly activated, and increase efficiency of uplink data transmission after the handover.

### CROSS-REFERENCE TO RELATED APPLICATIONS

This application is the National Stage Entry of International Application PCT/KR2012/004565, filed on Jun. 8, 2012, and claims priority from and the benefit of Korean Patent Application No. 10-2011-0056052, filed on Jun. 10, 2011, all of which are incorporated herein by reference in their entireties for all purposes as if fully set forth herein.

### BACKGROUND

1. Field

The present invention relates to wireless communication, and more particularly, to an apparatus and method for performing uplink synchronization in a multiple component carrier system.

2. Discussion of the Background

In a general wireless communication system, only a single carrier is mainly considered even though bandwidths of an uplink and a downlink are set to different from each other. The 3rd generation partnership project (3GPP) long term evolution (LTE) is also based on a single carrier, such that each of the numbers of carriers configuring the uplink and the downlink is 1 and bandwidths of the uplink and the downlink are generally symmetrical to each other. In this single carrier system, a random access has been performed using a single carrier. However, recently, as a multiple carrier system is introduced, the random access may be implemented through several component carriers.

The multiple carrier system means a wireless communication system that may support carrier aggregation. The carrier aggregation, which is a technology for efficiently using a segmented small band, is to generate an effect such as using a logically large band by bundling a plurality of physically non-continuous bands in a frequency domain.

A mobile station performs a random access process in order to access a network. The random access process may be divided into a contention based random access process and a non-contention based random access process. The largest difference between the contention based random access process and the non-contention based random access process is whether or not a random access preamble is specified so as to be dedicated to a single mobile station. In the case of the non-contention based random access process, since the mobile station uses the dedicated random access preamble specified only thereto, contention (or collision) with other mobile stations is not generated. Here, the contention indicates that two or more mobile stations attempt a random access process using the same random access preamble through the same resource. In the case of the contention based random access process, since the mobile station uses an arbitrary selected random access preamble, the possibility of contention is present.

An object of a random access process to a network performed by a mobile station may be initial access, handover, scheduling request, timing alignment, or the like.

### SUMMARY

The present invention provides an apparatus and method for performing uplink synchronization in a multiple component carrier system.

The present invention also provides an apparatus and method for transferring a timing alignment value in a handover procedure.

The present invention also provides an apparatus and method for transferring timing alignment group information using an RRC reconfiguration message.

In an aspect, a method for performing uplink synchronization by a mobile station is provided. The method includes: receiving a handover command message from a first base station, the handover command message including a timing alignment value for adjusting uplink timing of a secondary serving cell of a second base station; performing handover from the first base station to the second base station based on the handover command message; adjusting the uplink timing of the secondary serving cell of the second base station based on the timing alignment value; and performing a random access through the secondary serving cell of the second base station based on the adjusted uplink timing.

The handover command message may include a preamble index indicating a preamble selected among dedicated random access preambles reserved in advance for a non-contention based random access procedure and a physical random access channel (PRACH) mask index indicating available time or frequency resource information.

The preamble index and the PRACH mask index may be included in MCI in the handover command message.

The method may further include, after the performing of the random access, receiving a radio resource control (RRC) reconfiguration message from the second base station, wherein the RRC reconfiguration message includes timing alignment group information on serving cells to which the same timing alignment value is applied among serving cells in a timing alignment group including at least one serving cell.

In another aspect, a method for performing uplink synchronization by a base station is provided. The method includes: receiving a handover request message from a source base station, the handover request message including RRC configuration information of a mobile station and secondary serving cell configuration information of the mobile station; transmitting a handover admission message to the source base station, the handover admission message including information on whether or not secondary serving cells configured by the source base station are released and a timing alignment value for adjusting uplink timing of a secondary serving cell of the base station; and performing a random access with the mobile station through the secondary serving cell of the base station based on the uplink timing of the secondary serving cell of the base station adjusted based on the timing alignment value.

The method may further include, after the receiving of the handover request message, judging whether or not secondary serving cells configured by the source base station are released based on the RRC configuration information of the mobile station and a data traffic loading situation, a supportable frequency band, or a supportable release version of the base station.

In still another aspect, a mobile station for performing uplink synchronization is provided. The mobile station includes: a mobile station receiver receiving a handover command message from a first base station, the handover command message including a timing alignment value for adjusting uplink timing of a secondary serving cell of a second base station; and a random access processing unit performing handover from the first base station to the second base station based on the handover command message, adjusting the uplink timing of the secondary serving cell of the second base station based on the timing alignment value, and performing a random access through the secondary serving cell of the second base station based on the adjusted uplink timing.

In still another aspect, a base station for performing uplink synchronization is provided. The base station includes: a base station receiver receiving a handover request message from a source base station, the handover request message including RRC configuration information of a mobile station and secondary serving cell configuration information of the mobile station; a base station transmitter transmitting a handover admission message to the source base station, the handover admission message including information on whether or not secondary serving cells configured by the source base station are released and a timing alignment value for adjusting uplink timing of a secondary serving cell of the base station; and a random access processing unit performing a random access with the mobile station through the secondary serving cell of the base station based on the uplink timing of the secondary serving cell of the base station adjusted based on the timing alignment value.

According to the exemplary embodiments of the present invention, in the case of performing handover, deactivated secondary serving cells of a target base station are rapidly activated, thereby making it possible to more rapidly set a timing alignment group and acquire uplink synchronization, and increase efficiency of uplink data transmission after the handover.

### BRIEF DESCRIPTION OF DRAWINGS

FIG. 1 shows a wireless communications system according to an exemplary embodiment of the present invention.

FIG. 2 shows an example of a protocol structure for supporting multiple carriers according to the exemplary embodiment of the present invention.

FIG. 3 shows an example of a frame structure for a multiple carrier operation according to the exemplary embodiment of the present invention.

FIG. 4 shows linkage between a downlink component carrier and an uplink component carrier in a multiple carrier system according to the exemplary embodiment of the present invention.

FIG. 5 is a diagram showing an example of timing advance in a synchronizing process according to the exemplary embodiment of the present invention.

FIG. 6 is a flow chart describing a method for performing a random access procedure according to the exemplary embodiment of the present invention.

FIG. 7 is a flow chart describing a method for performing a random access procedure according to another exemplary embodiment of the present invention.

FIG. 8 is a diagram showing a process of applying uplink timing alignment values using downlink timing alignment values of a primary serving cell and a secondary serving cell.

FIG. 9 is a flow chart describing a method for performing a random access according to the exemplary embodiment of the present invention.

FIG. 10 is a flow chart showing a method for performing uplink synchronization according to the exemplary embodiment of the present invention.

FIG. 11 is a flow chart showing a method for performing uplink synchronization according to another exemplary embodiment of the present invention.

FIG. 12 is a flow chart showing a method for performing uplink synchronization of a mobile station according to the exemplary embodiment of the present invention.

FIG. 13 is a flow chart showing a method for performing uplink synchronization of a base station according to the exemplary embodiment of the present invention.

FIG. 14 is a block diagram showing the base station and the mobile station performing the uplink synchronization according to the exemplary embodiment of the present invention.

### DETAILED DESCRIPTION OF THE ILLUSTRATED EMBODIMENTS

Hereinafter, some exemplary embodiments in the present invention will be described in detail with reference to the illustrative drawings. It is to be noted that in adding reference numerals to elements of each drawing, like reference numerals refer to like elements even though like elements are shown in different drawings. Further, in describing the present invention, well-known functions or constructions will not be described in detail since they may unnecessarily obscure the understanding of the present invention.

In addition, in describing components of exemplary components of the present invention, terms such as first, second, A, B, (a), (b), etc. can be used. These terms are used only to differentiate the components from other components. Therefore, the nature, times, sequence, etc. of the corresponding components are not limited by these terms. When any components are “connected”, “coupled”, or “linked” to other components, it is to be noted that the components may be directly connected or linked to other components, but the components may be “connected”, “coupled”, or “linked” to other components via another component therebetween.

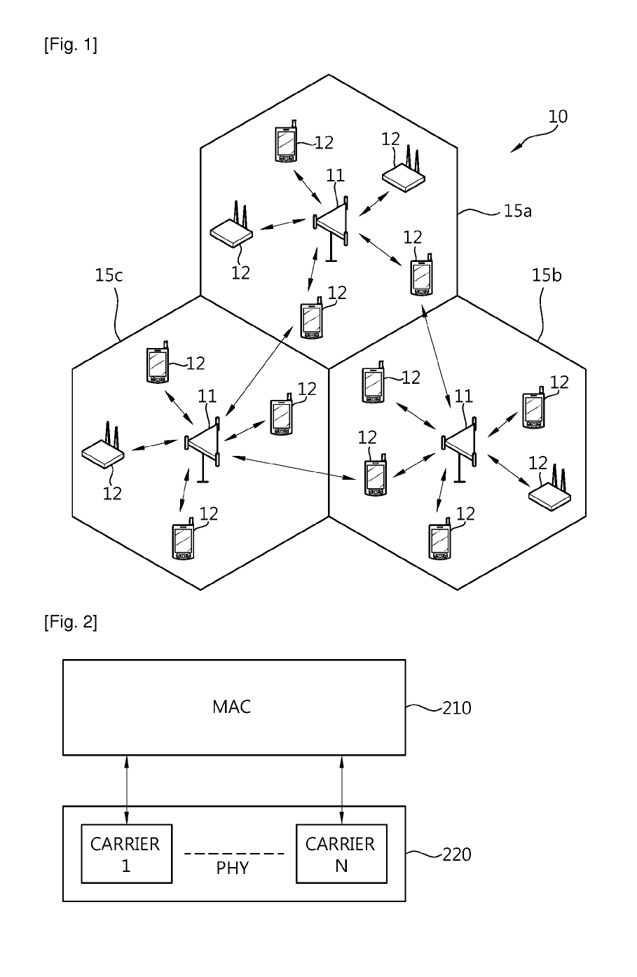

FIG. 1 shows a wireless communications system according to an exemplary embodiment of the present invention.

Referring to FIG. 1, the wireless communication system 10 is widely distributed in order to provide various communication services, such as audio, packet data, or the like. A wireless communication system 10 includes at least one base station (BS) 11. Each base station 11 provides communication services to specific cells 15a, 15b, and 15c. The cell may again be divided into a plurality of areas (referred to as sectors).

A mobile station (MS) 12 may be fixed or moved and may be referred to as other terms, such as a user equipment (UE), a mobile terminal (MT), a user terminal (UT), a subscriber station (SS), a wireless device, a personal digital assistant (PDA), a wireless modem, a handheld device, or the like. The base station 11 may be referred to as other terms, such as an evolved-Node B (eNB), a base transceiver system (BTS), an access point, a femto base station, a home nodeB, a relay, or the like. The cell is to be interpreted as comprehensive meaning indicating a partial area covered by the base station 11 and means including all of the various coverage areas such as a mega cell, a macro cell, a micro cell, a pico cell, a femto cell, or the like.

Hereinafter, a downlink means communication from the base station 11 to the mobile station 12, and an uplink means communication from the mobile station 12 to the base station 11. At the downlink, a transmitter may be a portion of the base station 11, and a receiver may be a portion of the mobile station 12. At the uplink, the transmitter may be a portion of the mobile station 12, and the receiver may be a portion of the base station 11. A multiple access method applied to the wireless communication system is not limited. Various multiple access methods such as code division multiple access (CDMA), time division multiple access (TDMA), frequency division multiple access (FDMA), orthogonal frequency division multiple access (OFDMA), single carrier-FDMA (SC-FDMA), OFDM-FDMA, OFDM-TDMA, OFDM-CDMA, or the like, may be used. In the uplink transmission and the downlink transmission, a time division duplex (TDD) scheme of performing transmission at different times or a frequency division duplex (FDD) scheme of performing transmission at different frequencies may be used.

Carrier aggregation (CA), which supports a plurality of carriers, is also referred to as spectrum aggregation or bandwidth aggregation. An individual unit carrier bundled by the carrier aggregation is referred to as component carrier (CC). Each component carrier is defined by a bandwidth and a center frequency. The carrier aggregation is introduced in order to support increasing throughput, prevent an increase in cost due to the introduction of a broadband radio frequency (RF) device, and secure compatibility with existing systems. For example, when five component carriers are allocated as granularity in a carrier unit having a bandwidth of 20 MHz, a bandwidth of maximum 100 MHz may be supported.

The carrier aggregation may be classified into contiguous carrier aggregation performed between continuous component carriers in frequency domain and non-continuous carrier aggregation performed between discontinuous component carriers. The numbers of carriers aggregated in the downlink and the uplink may be set to be different from each other. The case in which the number of downlink component carriers and the number of uplink component carriers are the same as each other may be referred to as symmetric aggregation and the case in which the number of downlink component carriers and the number of uplink component carriers are different from each other may be referred to asymmetric aggregation.

In addition, sizes (that is, bandwidths) of the component carriers may be different from each other. For example, when five component carriers are used to configure a 70 MHz band, they may be configured of 5 MHz component carrier (carrier #0)+20 MHz component carrier (carrier#1)+20 MHz component carrier (carrier#2)+20 MHz component carrier (carrier#3)+5 MHz component carrier (carrier#4).

Hereinafter, the multiple carrier system indicates a system supporting the carrier aggregation. In the multiple carrier system, the contiguous carrier aggregation and/or the non-contiguous carrier aggregation may be used, and either of the symmetric aggregation or the asymmetric aggregation may be used.

FIG. 2 shows an example of a protocol structure for supporting multiple carriers according to the exemplary embodiment of the present invention.

Referring to FIG. 2, a common medium access control (MAC) entity 210 manages a physical layer 220 that uses a plurality of carriers. An MAC management message transmitted by a specific carrier may be applied to other carriers. That is, the MAC management message is a message that may include the specific carrier to control other carriers. The physical layer 220 may be operated by time division duplex (TDD) and/or frequency division duplex (FDD).

There are some physical control channels used in the physical layer 220. A physical downlink control channel (PDCCH) informs the mobile station of information on to resource allocation of a paging channel (PCH) and a downlink shared channel (DL-SCH) and hybrid automatic repeat request (HARQ) associated with the DL-SCH. The PDCCH may carry an uplink grant informing the mobile station of the resource allocation of the uplink transmission. A physical control format indicator channel (PCFICH) informs the mobile station of the number of OFDM symbols used for the PDCCHs and is transmitted for each subframe. A physical hybrid ARQ indicator channel (PHICH) carries HARQ ACK/NAK signals as a response of the uplink transmission. A physical uplink control channel (PUCCH) carries uplink control information such as HARQ ACK/NAK for downlink transmission, scheduling request, CQI, or the like. A physical uplink shared channel (PUSCH) carries an UpLink shared channel (UL-SCH). A physical random access channel (PRACH) carries a random access preamble.

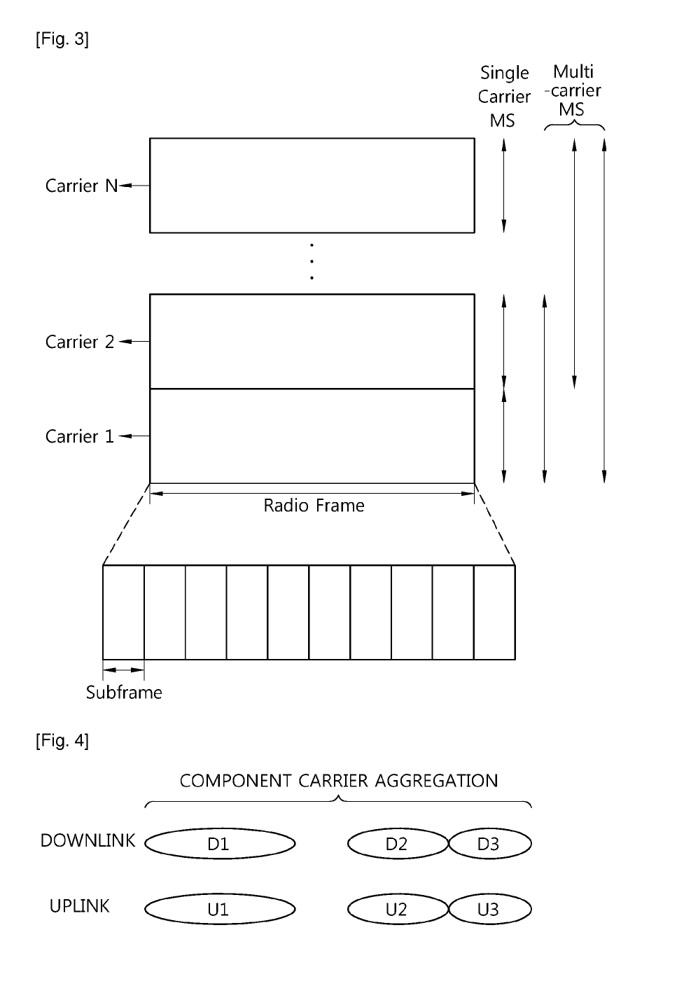

FIG. 3 shows an example of a frame structure for a multiple carrier operation according to the exemplary embodiment of the present invention.

Referring to FIG. 3, a frame is configured of ten subframes. The subframe includes a plurality of OFDM symbols. Each carrier may have its own control channel (for example, PDCCH). The multiple carriers may be contiguous to each other or may not be contiguous to each other. The mobile station may support one or more carrier according to its own capability.

The component carrier may be divided into a primary component carrier (PCC) and a secondary component carrier (SCC) according to whether or not it is activated. The primary component carrier is a carrier that is being activated at all times, and the secondary component carrier is a carrier that is activated/deactivated according to specific conditions. The activation means a state in which transmission or reception of traffic data is performed or is ready. The deactivation means a state in which the transmission or reception of the traffic data may not be performed but measurement or transmission or reception of minimum information may be performed. The mobile station may use only a single primary component carrier or one or more secondary component carrier together with the primary component carrier. The mobile station may be allocated with the primary component carrier and/or the secondary component carrier from the base station.

FIG. 4 shows linkage between a downlink component carrier and an uplink component carrier in a multiple carrier system according to the present invention.

Referring to FIG. 4, downlink component carriers D1, D2, and D3 are aggregated in the downlink and uplink component carriers U1, U2, and U3 are aggregated in the uplink. Here, Di is an index of the downlink component carrier, and Ui is an index of the uplink component carrier (i=1, 2, 3). At least one downlink component carrier is the primary component carrier, and the remainders are the secondary component carrier Likewise, at least one uplink component carrier is the primary component carrier, and the remainders are the secondary component carrier. For example, D1 and U1 are the primary component carriers, and D2, U2, D3, and U3 are the secondary component carriers.

In the FDD system, the downlink component carrier and the uplink component carrier are linked therebetween on a one-to-one basis. For example, the D1 and the U1, the D2 and the U2, and the D3 and the U3 are linked therebetween on a one-to-one basis, respectively. The mobile station performs the linkage between the downlink component carriers and the uplink component carriers through system information transmitted by a logical channel BCCH and mobile station dedicated RRC messages transmitted by DCCH. Each linkage may be set to be cell specific or may be set to be MS specific.

Although FIG. 4 shows only the one-to-one linkage between the downlink component carrier and the uplink component carrier by way of example, a 1:n or n:1 linkage may also be established. Further, an index of the component carriers does not necessarily correspond to an order of the component carriers or a position of frequency bands of corresponding component carriers.

The primary serving cell means one serving cell providing security input NAS mobility information in an RRC connection or re-connection state. According to capabilities of the mobile station, at least cell may be configured to form a set of serving cells together with the primary serving cell, wherein the at least cell is called a secondary serving cell.

Therefore, a set of serving cells set for a single mobile station may be configured only of a single primary serving cell or a single primary serving cell and at least one secondary serving cell.

A downlink component carrier corresponding to the primary serving cell is called a downlink primary component carrier (DL PCC), and an uplink component carrier corresponding to the primary serving cell is called an uplink primary component carrier (UL PCC). Further, in the downlink, a component carrier corresponding to the secondary serving cell is called a downlink secondary component carrier (DL SCC), and in the uplink, a component carrier corresponding to the secondary serving cell is called an uplink secondary component carrier (UL SCC). Only the downlink component carrier may correspond to the single serving cell or both of the DL CC and the UL CC may correspond thereto.

Therefore, in a carrier system, the concept that communication between the mobile station and the base station is performed through the DL CC or the UL CC is the same as the concept that the communication between the mobile station and the base station is performed through the serving cell. For example, in a method for performing a random access according to the present invention, the concept that the mobile station transmits a preamble using the UL CC may be considered as the same concept as the concept that the mobile station transmits the preamble using the primary serving cell or the secondary serving cell. Further, the concept that the mobile station receives downlink information using the DL CC may be considered as the same concept as the concept that the mobile station receives the downlink information using the primary serving cell or the secondary serving cell.

Meanwhile, the primary serving cell and the secondary serving cell have the following characteristics.

First, the primary serving cell is used to transmit the PUCCH. On the other hand, the secondary serving cell may not transmit the PUCCH; however, it may transmit partial control information in information in the PUCCH through the PUSCH.

Second, the primary serving cell is always being activated. On the other hand, the secondary serving cell is a carrier activated/deactivated according to a specific condition. The specific condition may be the case in which an activating/deactivating MAC control element message of the base station is received or an inactivating timer in the mobile station expires.

Third, when the primary serving cell experiences radio link failure (hereinafter, referred to as RLF), RRC reconnection is triggered. On the other hand, when the secondary serving cell experiences the RLF, the RRC reconnection is not triggered. The RLF occurs in the case in which downlink performance is maintained at a threshold or less for a predetermined time or more or an RACH fails by the number of times of a threshold or more.

Fourth, the primary serving cell may be changed by a security key change or a handover procedure accompanied with the RACH procedure. However, in the case of a contention resolution (CR) message, a downlink control channel (hereinafter, referred to as a PDCCH) indicating CR may be transmitted through the primary serving cell, and CR information may be transmitted through the primary serving cell or the secondary serving cell.

Fifth, non-access stratum (NAS) information is received through the primary serving cell.

Sixth, in the primary serving cell, the DL PCC and the UL PCC are always configured in pair.

Seventh, each mobile station may set different CC as the primary serving cell.

Eighth, procedures such as reconfiguration, adding, removal, and the like, of the secondary serving cell may be performed by a radio resource control (RRC) layer. In adding a new secondary serving cell, RRC signaling may be used to transmit system information of a dedicated secondary serving cell.

Ninth, the primary serving cell may provide both of the PDCCH (for example, downlink allocation information or uplink grant information) allocated to a MS-specific search space set in order to transmit control information only to a specific mobile station in an area in which the control information is transmitted and the PDCCH (for example, system information (SI), random access response (RAR), and transmit power control (TPC)) allocated to a common search space set in order to transmit the control information to all mobile stations in the cell or a plurality of mobile stations that are in accordance with a specific condition. On the other hand, the secondary serving cell may be set only in a MS-specific search space. That is, since the mobile station may not confirm a common search space through the secondary serving cell, it may not receive control information transmitted only through the common search space and data information indicated by the control information.

The spirit of the present invention regarding characteristics of the primary serving cell and the secondary serving cell is not limited to the above-mentioned description that is only an example, but may include more examples.

Meanwhile, in a wireless communication environment, a propagation delay is generated during a process in which an electric wave is propagated from a transmitter and transferred to a receiver. Therefore, even though both of the transmitter and the receiver recognize a time at which the electric wave is propagated from the transmitter, a time at which the electric wave arrives at the receiver is affected by a distance between the transmitter and the receiver, a surrounding propagation environment, or the like, and is changed over time in the case in which the receiver moves. In the case in which the receiver does not accurately recognizes a point in time at which a signal transferred by the transmitter is received, the receiver fails to receive the signal or receives a distorted signal even though it receives the signal, such that communication is impossible.

Therefore, in the wireless communication system, the base station and the mobile station need to be necessarily synchronized with each other in order to receive an information signal regardless of the downlink/uplink. As a kind of synchronization, there are various sychronizations such as frame synchronization, information symbol synchronization, sampling period synchronization, and the like. Here, the sampling period synchronization is synchronization that needs to be the most basically acquired in order to identify physical signals.

The downlink synchronization acquisition may be performed in the mobile station based on a signal of the base station. The base station transmits a mutually promising specific signal so as to allow the mobile station to easily acquire the downlink synchronization. The mobile station needs to accurately recognize a time at which the specific signal is transmitted from the base station. In the case of the downlink, since a single base station simultaneously transmits the same synchronization signal to a plurality of mobile stations, each of the mobile stations may independently acquire the synchronization.

In the case of the uplink, the base station receives signals transmitted from the plurality of mobile stations. In the case in which distances between each mobile station and base station are different, the signals received by each base station have different transmission delay times, and in the case in which each mobile station transmits the uplink information based on the acquired downlink synchronization, information of each mobile station is received in corresponding base stations at different times. In this case, the base station may not acquire the synchronization based any one mobile station. Therefore, in order to acquire the uplink synchronization, a procedure different from a procedure for acquiring the downlink synchronization is required.

Meanwhile, the necessities for the uplink synchronization acquisition may be different according to each multiple access scheme. For example, in the case of a CDMA system, even though the base station receives the uplink signals of different mobile stations at different times, the base station may separate the respective uplink signals from each other. However, in an OFDMA or FDMA based wireless communication system, the base station simultaneously receives the uplink signals of all of the mobile stations and demodulates them at a time. Therefore, the more accurate the time at which the uplink signals of the plurality of mobile stations are received, the higher the reception performance, and the larger the difference between times at which the signals of each mobile station are received, the lower the reception performance. Therefore, it is necessary to acquire the uplink synchronization.

A random access procedure is performed in order to acquire the uplink synchronization, and the mobile station acquires the uplink synchronization by adjusting uplink timing based on a timing alignment value transmitted from the base station during the random access process. When a predetermined time elapses after the uplink synchronization is acquired based on the timing alignment value, it needs to be judged that the acquired uplink synchronization is valid. To this end, the mobile station defines a timing alignment timer (TAT) that may be configured by the base station and needs to start an uplink synchronization acquisition procedure at the time of expiration thereof. When the timing alignment timer is being operated, the mobile station and the base station are in a state in which the uplink synchronization therebetween is made. When the timing alignment timer expires or is not operated, the mobile station and the base station regards that they are not synchronized with each other, and the mobile station does not perform the uplink transmission other than transmission of a random access preamble. The timing alignment timer is operated specifically as follows.

i) in the case in which the mobile station receives a timing advance command from the base station through an MAC control element, the mobile station applies a timing alignment value indicated by the received timing advance command to the uplink synchronization. In addition, the mobile station starts or restarts the timing alignment timer.

ii) in the case in which the mobile station receives the timing advance command through a random access response message from the base station, when the random access response message is not selected in an MAC layer of the mobile station (a), the mobile station applies a timing alignment value indicated by the timing advance command to the uplink synchronization and starts or restarts the timing alignment timer. Alternatively, in the case in which the mobile station receives the timing advance command through the random access response message from the base station, when the random access response message is selected in the MAC layer of the mobile station and the timing alignment timer is not operated (b), the mobile station applies a timing alignment value indicated by the timing advance command to the uplink synchronization, starts the timing alignment timer, and stops the timing alignment timer when contention resolution that is a subsequent random access step fails. Alternatively, in the case other than (a) and (b), the mobile station ignores the timing advance command.

iii) when the timing alignment timer expires, the mobile station flushes data stored in all HARQ buffers. In addition, the mobile station informs release of a PUCCH/sounding reference signal (SRS) of an RRC layer. The SRS indicates a sounding reference signal. Here, a type 0 of SRS (a periodic SRS) is released, and a type 1 of SRS (a non-periodic SRS) is not released. The mobile station clears all configured downlink and uplink resource allocations.

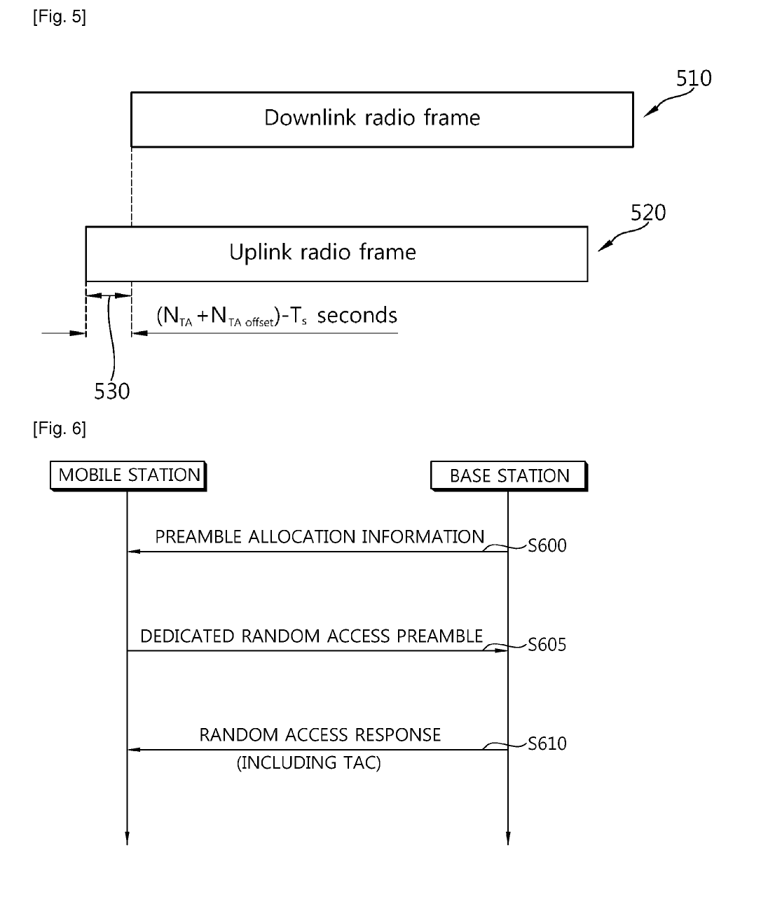

FIG. 5 is a diagram showing an example of timing advance (TA) in a synchronizing process according to the exemplary embodiment of the present invention.

Referring to FIG. 5, an uplink radio frame 520 needs to be transmitted at a point in time at which a downlink radio frame 510 is transmitted in order to perform communication between the base station and the mobile station. In consideration of a timing difference generated due to a propagation delay between the mobile station and the base station, the mobile station transmits the uplink radio frame 520 at a time earlier than the point in time at which the downlink radio frame 510 is transmitted, thereby making it possible to apply the timing advance so that the base station and the mobile station are synchronized with each other.

The timing advance (TA) at which the mobile station adjusts uplink timing may be calculated by the following Equation 1.

TA=(N_{TA}+N_{TA}_{_{—}}_{offset})×Tₛ [Equation 1]

Where N_{TA} which is a timing alignment value is variably controlled by a timing advance command of the base station, and N_{TA}_{_{—}}_{offset} indicates a value fixed by a frame structure. Tₛ indicates a sampling period. Here, when the timing alignment value (N_{TA}) is positive (+), it is commanded that the uplink timing is adjusted so as to be advanced, and when the timing alignment value (N_{TA}) is negative (−), it is commanded that the uplink timing is adjusted so as to be delayed.

In order to perform the uplink synchronization, the mobile station may receive a timing alignment value provided by the base station and apply the timing advance based on the timing alignment value, thereby acquiring the synchronization for wireless communication with the base station.

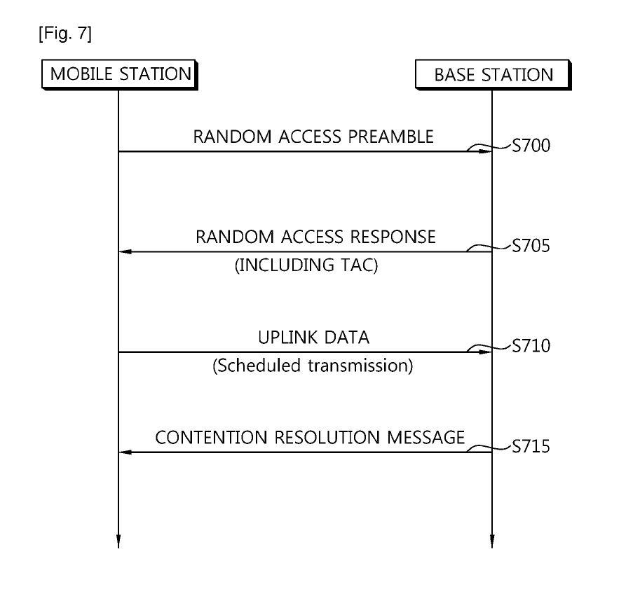

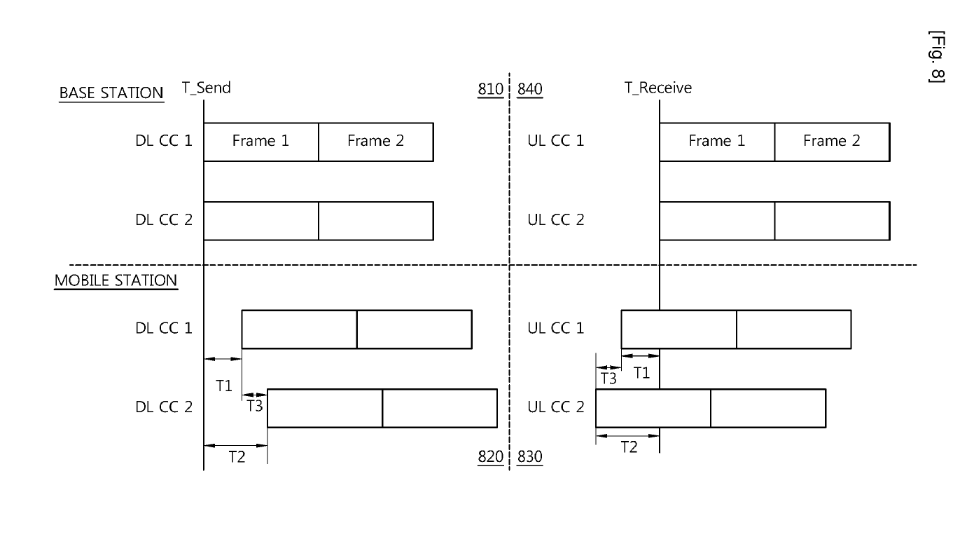

A random access procedure according to the exemplary embodiment of the present invention will be described. The random access procedure may be a non-contention based random access procedure or a contention based random access procedure. The non-contention based random access procedure may be initiated by a random access procedure performing order by the base station. A detailed process thereof will be described with reference to FIG. 6. In addition, the contention based random access procedure may be initiated by transmitting, in the mobile station, a randomly selected random access preamble to the base station. A detailed process thereof will be described with reference to FIG. 7.

FIG. 6 is a flow chart describing a method for performing a random access procedure according to the exemplary embodiment of the present invention. This procedure is a non-contention based random access procedure.

Referring to FIG. 6, the base station selects one of dedicated random access preambles reserved in advance for the non-contention based random access procedure among all available random access preambles and transmits random access (RA) preamble assignment information including an index of the selected random access preamble and available time/frequency resource information to the mobile station (S600). The mobile station needs to be allocated with a dedicated random access preamble that does not have collision possibility from the base station in order to perform a non-contention based random access process.

As an example, in the case in which the random access procedure is performed during a handover process, the mobile station may obtain the dedicated random access preamble from a handover command message. A detailed description thereof will be described below with reference to FIG. 10.

Another example, in the case in which the random access procedure is performed by a request of the base station, the mobile station may obtain the dedicated random access preamble through the PDCCH, that is, the physical layer signaling. In this case, the physical layer signaling, which is a downlink control information (DCI) format 1A, may include fields as shown in Table 1.

TABLE 1
Carrier indicator field (CIF) - 0 or 3 bits.
Flag for identifying formats 0/1A - 1 bit (in the case in which the
flag is 0, it indicates the format 0, and in the case in which the flag is 1, it
indicates the format 1A).
In the case in which a format 1A CRC is scrambled by a C-RNTI
and remaining fields are set as follows, the format 1A is used for a random
access procedure initiated by a PDCCH command.
below -
Localized/distributed VRB allocation flag - 1 bit. Set to 0.
Resource block allocation-
┌log₂(N_{RB}^{DL}(N_{RB}^{DL} + 1)/2┐ bits. All bits are set to 1.
Preamble Index - 6 bits
PRACH mask index - 4 bits.
All remaining bits of the format 1A for simple scheduling
allocation of a single PDSCH codeword are set to 0.

Referring to Table 1, the preamble index is an index indicating one preamble selected among the dedicated random access preambles reserved in advance for the non-contention based random access procedure, and the PRACH mask index indicates available time/frequency resource information. The available time/frequency resource information indicates different resources according to a frequency division duplex (FDD) system and a time division duplex (TDD) system as shown in Table 2.

TABLE 2

| PRACH | | |
|---|---|---|
| mask index | Allowed PRACH (FDD) | Allowed PRACH (TDD) |
| 0 | All | All |
| 1 | PRACH resource index 0 | PRACH resource index 0 |
| 2 | PRACH resource index 1 | PRACH resource index 1 |
| 3 | PRACH resource index 2 | PRACH resource index 2 |
| 4 | PRACH resource index 3 | PRACH resource index 3 |
| 5 | PRACH resource index 4 | PRACH resource index 4 |
| 6 | PRACH resource index 5 | PRACH resource index 5 |
| 7 | PRACH resource index 6 | Reserved |
| 8 | PRACH resource index 7 | Reserved |
| 9 | PRACH resource index 8 | Reserved |
| 10 | PRACH resource index 9 | Reserved |
| 11 | All even-numbered | All even-numbered PRACH |
| | PRACH opportunities in | opportunities in time domain, |
| | time domain, First | First PRACH resource index in |
| | PRACH resource | subframe |
| | index in subframe | |
| 12 | All odd-numbered | All odd-numbered PRACH |
| | PRACH opportunities in | opportunities in time domain, |
| | time domain, First | First PRACH resource index in |
| | PRACH resource | subframe |
| | index in subframe | |
| 13 | Reserved | First PRACH resource index in |
| | | subframe |
| 14 | Reserved | Second PRACH resource index |
| | | in subframe |
| 15 | Reserved | Third PRACH resource index in |
| | | subframe |

The mobile station transmits the allocated dedicated random access preamble to the base station through the secondary serving cell (S605). The random access preamble may be transmitted after the secondary serving cell is activated. The random access preamble may be applied to the contention based random access procedure as well as the non-contention based random access procedure according to intention of the base station.

The base station transmits a random access response message to the mobile station (S610). As an example, the random access response message includes a timing advance command (TAC) field. The timing advance command field indicates a relative change in uplink timing for current uplink timing and may be an integer multiple, for example, 16 Tₛ, of sampling timing (Tₛ). The timing advance command field indicates an updated timing alignment value regarding the secondary serving cell. The updated timing alignment value may be given by a specific index.

The base station may confirm through which secondary serving cell which mobile station has transmitted the random access preamble based on the received random access is preamble and time/frequency resources. That is, the number of mobile stations having the same RA-radio network temporary identities (RA-RNTIs) may be plural; however, the number of mobile stations using the same random access preamble is only one. Therefore, the random access response message is transmitted to the mobile station through a physical downlink shared channel (PDSCH) indicated by a PDCCH scrambled by the RA-RNTI of the mobile station.

Unlike the contention based random access process, in the non-contention based random access process, since a mobile station identifier such as a cell-RNTI (C-RNTI) in the random access response message is also received, it may be judged whether the random access process is normally performed. Therefore, in the case in which it is judged that the random access process is normally performed, the random access process ends. In the case in which the preamble index in the preamble allocation information received by the mobile station is ‘000000’, the mobile station randomly selects one of the contention based random access preambles, sets a value of the PRACH mask index to ‘0’, and then perform the contention based procedure. In addition, the preamble allocation information may be transmitted to the mobile station through an upper layer message (for example, MCI mobility control information in a handover command) such as the RRC.

FIG. 7 is a flow chart describing a method for performing a random access procedure according to another exemplary embodiment of the present invention. This procedure is the contention based random access procedure.

The mobile station requires the uplink synchronization in order to transmit and receive data to and from the base station. The mobile station may perform a process of receiving information required for synchronization from the base station in order to perform the uplink synchronization. A random access process may also be applied in the case in which the mobile station is newly connected to a network through handover, or the like, and be performed in various situations such as synchronization, a change in state of the RRC from the RRC_IDLE to the RRC_CONNECTED, and the like, after the mobile station is connected to the network.

Referring to FIG. 7, the mobile station arbitrarily selects one preamble sequence in a set of random access preamble sequences and transmits a random access preamble according to the selected preamble sequence to the base station using a PRACH resource of the secondary serving cell (S700). The random access preamble may be transmitted after the secondary serving cell is activated. In addition, the random access procedure for the secondary serving cell may be initiated by the PDCCH command transmitted by the base station.

Information on a configuration of the set of random access preambles may be obtained from the base station through a portion of system information or a handover command message. Here, the mobile station may recognize the RA-RNTI in consideration of an arbitrarily selected frequency resource and a transmission point in time in order to select the preamble or transmit the RACH.

The base station transmits a random access response message as a response to the received random access preamble of the mobile station to the mobile station (S705). At this time, the PDSCH is used. The random access response message includes a timing advance command for the uplink synchronization of the mobile station, uplink radio resource allocation information, a random access preamble identifier (RAPID) for identifying the mobile stations performing a random access, information on a time slot in which the random access preamble of the mobile station is received, and a temporary identifier of the mobile station such as a temporary C-RNTI. The random access preamble identifier is to identify the received random access preamble.

The mobile station transmits uplink data including the random access identifier to the base station on the PUSCH according to an uplink time adjusted based on the timing alignment value indicated by the timing advance command (S710). The uplink data may include an RRC connection request, a tracking area update, a scheduling request, or a buffer station report for data to be transmitted to the uplink by the mobile station. The random access identifier may include an arbitrary C-RNTI, a C-RNTI (in a state in which it is included in the mobile station), mobile station contention resolution identifier information, or the like. As the timing alignment value is applied, the mobile station starts or restarts the timing alignment timer. The mobile station restarts the timing alignment timer when the timing alignment timer is being operated in advance and starts the timing alignment timer when the timing alignment timer is not being operated in advance.

Since the transmissions of the random access preambles by several mobile stations may collide with each other in a process of steps (S700 to 710), the base station transmits a contention resolution message informing that the random access successfully ends to the mobile stations (S715). The contention resolution message may include the random access identifier. In a contention based random access process, the contention is generated since the number of possible random access preambles is limited. Since a unit random access preamble may not be imparted to all of the mobile stations in the cell, the mobile stations arbitrarily select and transmit one random access preamble in a set of random access preambles. Therefore, two or more mobile stations may select and transmit the same random access preamble through the same PRACH resource.

In this case, all of the transmissions of the uplink data fail or the base station successfully receives only uplink data of a specific mobile station according to positions or transmit power of the mobile stations. In the case in which the base station successfully receives the uplink data, the base station transmits the contention resolution message using the random access identifier included in the uplink data. The mobile station receiving its random access identifier may recognize whether or not the contention resolution is successful. Allowing the mobile station to recognize whether the contention fails or succeeds in the contention based random access process is called the contention resolution.

When the mobile station receives the contention resolution message, the mobile station confirms whether the contention resolution message is its own. When it is confirmed that the contention resolution message is its own, the mobile station transmits ACK to the base station, and when it is confirmed that the contention resolution message is another mobile station's own, the mobile station does not transmit response data. In addition, the mobile station does not also transmit the response message in the case in which it misses downlink allocation is missed or may not decode the message. In addition, the contention resolution message may include the C-RNTI, the mobile station identifier information, or the like.

Hereinafter, an application of multiple timing advance (MTA) will be described.

In the multiple carrier system, a single mobile station communicates with the base station through the plurality of component carriers or the plurality of serving cells. When each of the signals of the plurality of serving cells set for the mobile station has different time delays, it is required for the mobile station to apply different timing alignment values to each serving cell.

FIG. 8 is a diagram showing a process of applying uplink timing alignment values using downlink timing alignment values of a primary serving cell and a secondary serving cell. DL CC1 and UL CC1 are the primary serving cells, and DL CC2 and UL CC2 are the secondary serving cells.

Referring to FIG. 8, when the base station transmits a frame through the DL CC1 and the DL CC2 at a point in time (T_Send) (810), the mobile station receives the frame through the DL CC1 and the DL CC2 (820). The mobile station receives the frame at a point in time delayed by a propagation delay time after the point in time (T_Send) at which the base station transmits the frame. In the DL CC1, a propagation delay corresponding to T1 is generated, such that the frame is received at a point in time delayed by T1, and in the DL CC2, a propagation delay corresponding to T2 is generated, such that the frame is received at a point in time delayed by T2.

When it is assumed that a propagation delay time of the downlink transmission and a propagation delay time of the uplink transmission are the same as each other, the mobile station may apply TAs corresponding to T1 and T2 to the UL CC1 and the UL CC2, respectively, to transmit the frame the base station (830). As a result, the base station may receive the frame transmitted by the mobile station through the UL CC1 and the UL CC2 at a point in time (T_Receive) set for uplink synchronization (840).

Hereinabove, the case in which the base station receives the UL CC1 and the UL CC2 through a single receiving apparatus has been assumed. Therefore, in the case in which the base station includes apparatuses capable of independently receiving each UL CC, the points in time (T_Receive) set by the base station need not to be the same as each other with respect to all of the UL CCs. That is, the point in time (T_Receive) may be set for each UL CC. However, points in time at which the uplink frames transmitted by the mobile stations using each UL CC arrives need to be same each other, that is, need to be the point in time (T_Receive).

A deactivating operation of the mobile station for a deactivated secondary serving cell is as follows. i) With respect to the secondary serving cell, the mobile station stops an operation of a deactivation timer regarding the secondary serving cell. ii) With respect to a DL SCC corresponding to the secondary serving cell, the mobile station stops monitoring of the PDCCH for a control region of the secondary serving cell. The mobile station also stops a PDCCH monitoring operation of a control region set for scheduling of the secondary serving cell within the entire control region in the secondary serving cell set for cross component carrier scheduling (CCS). The mobile station does not ‘receive’ information on downlink and uplink resource allocation in the secondary serving cell. The mobile station does not react to the downlink and uplink resource allocation in the secondary serving cell. Here, the ‘reaction’ may include transmission of ACK/NACK information meaning that reception of information on the resource allocation succeeds or fails. The mobile station does not process the downlink and uplink resource allocation for the secondary serving cell. For example, the ‘processing’ may include both of the ‘reception’ and ‘reaction’ operations.

iii) With respect to a UL SCC corresponding to the secondary serving cell, the mobile station stops transmission of a periodic SRS and an aperiodic SRS. In addition, the mobile station stops reporting of channel quality information (CQI). Further, the mobile station stops transmission or retransmission of the PUSCH.

An activation operation of the mobile station for the activated secondary serving cell is to execute all of the operations stopped in the deactivation operation. The activation operation includes an uplink activation operation and a downlink activation operation. For example, the downlink activation operation includes an operation of the mobile station initiating an operation of the deactivation timer regarding the secondary serving cell, performing the monitoring of the PDCCH for the control region of the secondary serving cell with respect to the DL SCC corresponding to the secondary serving cell, or processing the downlink and uplink resource allocation for the secondary serving cell. In addition, the uplink activation operation includes an operation of performing transmission of an uplink signal in the mobile station. For example, the mobile station performs the transmission of the periodic SRS or the aperiodic SRS with respect to the UL SCC corresponding to the secondary serving cell or performs the reporting of the channel quality information. Alternatively, the uplink activation operation includes an operation of performing transmission or retransmission of the PUSCH in the mobile station.

A message for the activation operation (or the deactivation operation) may be transmitted in a form of a medium access control (MAC) message. For example, the MAC message includes an MAC subheader and an MAC control element. Here, the MAC subheader includes a logical channel identifier (LCID) field indicating that a corresponding MAC control element is an MAC control element indicating the activation or the deactivation of the serving cell. An example of a content indicated by the LCID field value is as shown in Table 3.

TABLE 3

| LCID Index | LCID Value |
|---|---|
| 00000 | CCCH |
| 00001-01010 | Identifier of Logical Channel |
| 01011-11010 | Reserved |
| 11011 | Activation/Deactivation |
| 11100 | Mobile Station Contention Resolution Identifier |
| 11101 | Timing Advance Command (TAC) |
| 11110 | DRX Command |
| 11111 | Padding |

Referring to FIG. 3, when the LCID value is 11011, a corresponding MAC control element is an MAC control element indicating activation or deactivation of the serving cell.

The MAC control element indicating activation or deactivation of the serving cell may indicate the activation or the deactivation for each serving cell in a bitmap format having an octet structure of 8 bits. In addition, position of each bit is mapped to a serving cell of a specific index in a one-to-one scheme. For example, the least significant bit (LSB) may be mapped to a serving cell of an index 0, and the most significant bit (MSB) may be mapped to a serving cell of an index 7. Alternatively, the least significant bit may mean a cell index of the primary serving cell. In this case, a bit mapped to the primary serving cell does not have the meaning of the activation or the deactivation. When a bit is ‘0’, it may indicate that a serving cell corresponding to the bit is deactivated, and when a bit is ‘1’, it may indicate that a serving cell corresponding to the bit is activated. Meanwhile, bit information of a position mapped to the secondary serving cell that is not configured for the mobile station is not considered or is ignored by the mobile station or may be uniformly set to a specific value, for example, ‘0’ by the base station.

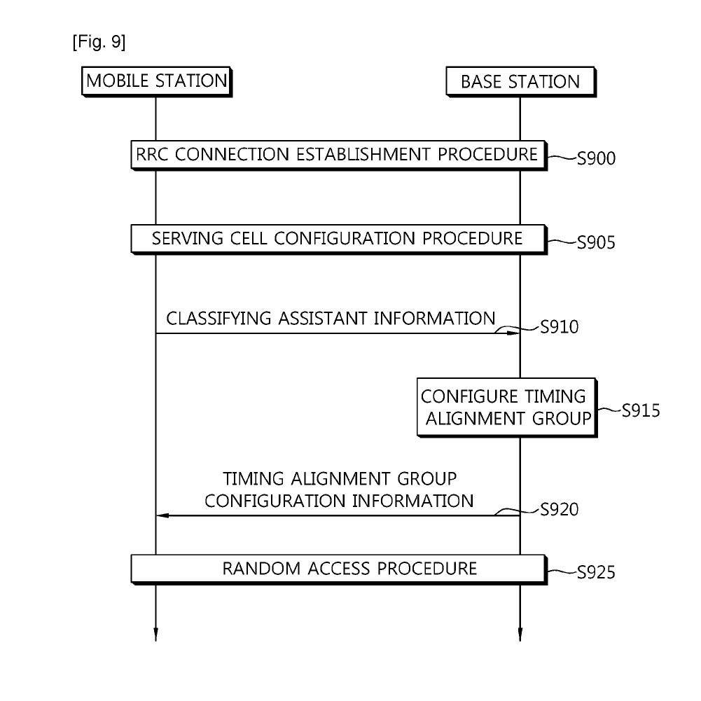

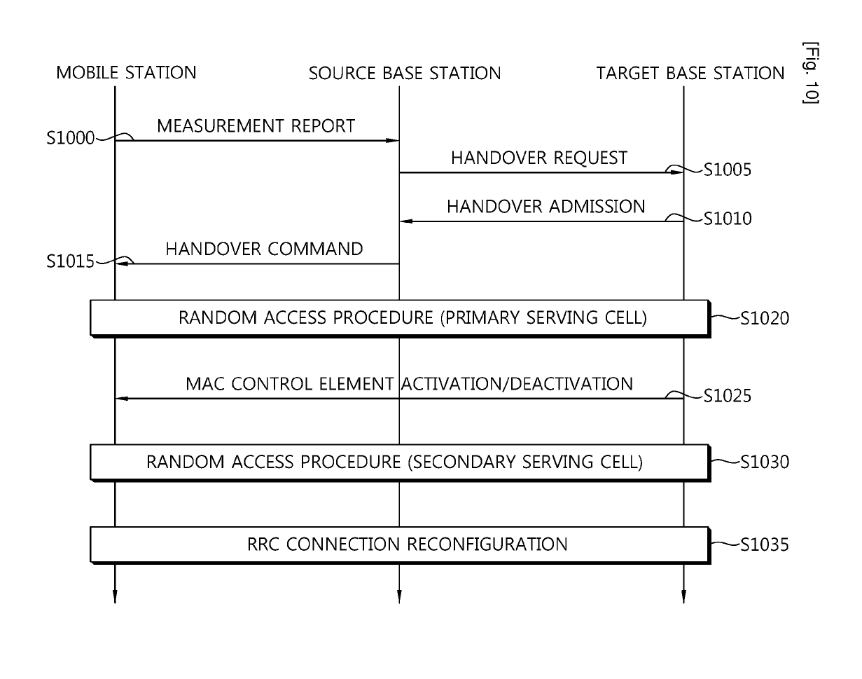

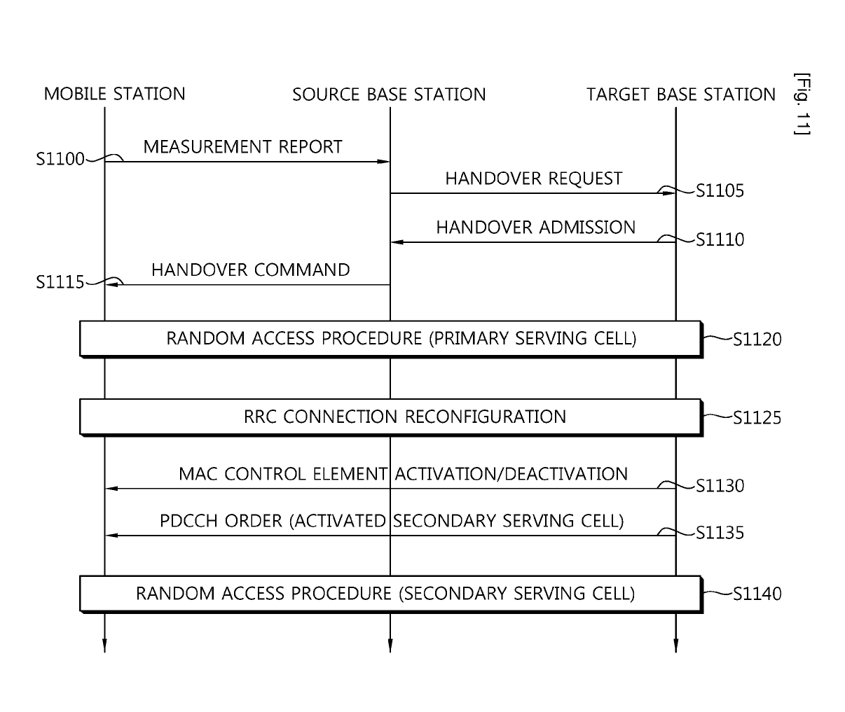

Meanwhile, the method for performing uplink synchronization is based on the assumption that specific serving cells are configured for the mobile station and each serving cell is in an activation or deactivation state and is additionally based on the assumption that each serving cell may be classified in a timing alignment group unit. In order to satisfy these preconditions, procedures that should be completed in advance are required, which will be described with reference to FIG. 9.

FIG. 9 is a flow chart describing a method for performing a random access according to the exemplary embodiment of the present invention.

Referring to FIG. 9, when a mobile station in a radio resource control (RRC) idle mode may not aggregate the component carrier and only a mobile station in a RRC connected mode may aggregate the component carrier, the mobile station selects a cell for RRC connection prior to aggregation of the component carrier and performs an RRC connection establishment procedure through the selected cell (S900). The RRC connection setup procedure is performed by transmitting, in the mobile station, an RRC connection request message to the base station, transmitting, in the base station, an RRC connection setup to the mobile station, and transmitting, in the mobile station, an RRC connection setup completion message to the base station. The RRC connection setup procedure includes a setup of an SRB1.

Meanwhile, the cell for the RRC connection is selected based on the following selection conditions.

(i) The mobile station may select the most suitable cell to which it will attempt radio resource control connection based on measured information. The mobile station considers both of RSRP measured based on a received cell-specific reference signal (CRS) and RSRQ defined as a ratio of an RSRP value for a specific cell (denominator) to the entire received power (numerator) as the measured information. Therefore, the mobile station secures the RSRP and RSRQ values for each of the identifiable cells to select the suitable cell based on the above-mentioned values. For example, the mobile station may set a weight (for example 7:3) with respect to cells in which both of the RSRP and RSRQ values are 0 dB or more and the RSRP value is the largest or the RSRQ value is the largest or each of the RSRP and RSRQ values select a suitable cell based on an average value in consideration of the weight.

(ii) The mobile station may attempt the radio resource control connection using information on a service operator (public land mobile network (PMLN)) stored in an internal memory thereof and fixedly set in a system, downlink center frequency information, or cell identifying information (for example, a physical cell ID). The stored information may be configured of information on a plurality of service operators and cells, wherein each information may have a priority or a preferential weight set thereto.

(iii) The mobile station may receive system information transmitted from the base station through a broadcasting channel and confirm information in the received system information to attempt the radio resource control connection. For example, the mobile station needs to confirms whether or not a cell is a specific cell (for example, a closed subscriber group (CSG), a non-allowed home base station, or the like) requiring membership in being accessed. Therefore, the mobile station receives the system information transmitted by each base station to confirm CSG ID information indicating whether or not the cell is the CSG. When it is confirmed that the cell is CSG, the mobile station confirms whether the cell is an accessible CSG. In order to confirm access possibility, the mobile station may use its membership information and unique information (for example, an evolved-cell global ID (E-CGI) or PCI information in the system information) of the CSG cell. In the case in which it is confirmed through the confirmation procedure that a base station is an inaccessible base station, the mobile station does not attempt the radio resource control connection.

(iv) The mobile station may attempt the radio resource control connection through valid component carriers (for example, component carriers capable of being configured in a frequency band that may be supported on implementation by the mobile station) stored in the internal memory thereof.

(ii) and (iv) conditions among the above-mentioned four selection conditions may be optionally applied; however, (i) and (iii) conditions thereamong may be mandatorily applied.

In order to attempt the radio resource control connection through the cell selected for the RRC connection, the mobile station needs to confirm an uplink band through which an RRC connection request message is to be transmitted. Therefore, the mobile station receives the system information through a broadcasting channel transmitted through a downlink of the selected cell. A system information block 2 (SIB2), which is one of system information, includes bandwidth information and center frequency information on a band to be used in the uplink. Therefore, the mobile station attempts the RRC connection through the downlink of the selected cell and the uplink band linked through the information in the downlink and the SIB2. In this case, the mobile station may transfer the RRC connection request message as the uplink data to the base station within the random access procedure. In the case in which the RRC connection procedure succeeds, the RRC connection set cell may be called the primary serving cell, which is configured of a DL PCC and a UL PCC.

In the case in which the base station allocates more radio resources to the mobile station by a request of the mobile station, a request of the network, or its judgment, the base station performs an RRC connection reconfiguration procedure for additionally configuring one or more secondary serving cell (SCell) for the mobile station (S905). The RRC connection reconfiguration procedure is performed by transmitting, in the base station, an RRC connection reconfiguration message to the mobile station and transmitting in the mobile station, an RRC connection reconfiguration completion message to the base station.

The mobile station transmits classifying assistant information to the base station (S910). The classifying assistant information provides information or reference required to classify at least one serving cell configured for the mobile station into a timing alignment group. For example, the classifying assistant information may include at least one of geographic position information of the mobile station, measurement information on neighboring cells of the mobile station, network deployment information, and serving cell configuration information. The geographic position information of the mobile station indicates a position of the mobile station that may be represented by latitude, longitude, a height, or the like. The measurement information on neighboring cells of the mobile station includes reference signal received power (RSRP) or reference signal received quality (RSRQ) transmitted from the neighboring cells. The network deployment information is information indicating deployment of the base station, a frequency selective repeater (FRS), or a remote radio head (RRH). The serving cell configuration information is information on the serving cell configured for the mobile station. Although the case in which the mobile station transmits the classifying assistant information to the base station is shown in step (S910), the base station may separately recognize the classifying assistant information or possess the classifying assistant information in advance. In this case, the random access according to the present embodiment may also be performed in a state in which step (S910) is omitted.

The base station classifies the serving cells to configure a timing advance group (TAG) (S915). The serving cells may be classified into or configured of each timing alignment group according to the classifying assistant information. The timing alignment group is a group including at least one serving cell. The same timing alignment value is applied to the serving cells in the timing alignment group. For example, when first and second serving cells belong to is the same timing alignment group (TAG1), the same timing alignment value (TA1) is applied to the first and second serving cells. On the other hand, when first and second serving cells belong to different timing alignment groups (TAG1 and TAG2), different timing alignment values (TA1 and TA2) are applied to the first and second serving cells, respectively. The timing alignment group may include the primary serving cell, include at least one secondary serving cell, or include the primary serving cell and at least one secondary serving cell.

The base station transmits timing alignment group (TAG) configuration information to the mobile station (S920). At least one serving cell configured for the mobile station is classified into a timing alignment group. That is, the timing alignment group configuration information describes a state in which the timing alignment group is configured. As an example, the timing alignment group configuration information may include a field indicating the number of timing alignment groups, an index field of each timing alignment group, and an index field of the serving cells included in each timing alignment group, wherein these fields describe a state in which the timing alignment group is configured.

As another example, the timing alignment group configuration information may further include information on a representative serving cell in the each timing alignment group. The representative serving cell is a serving cell capable of performing a random access procedure for maintaining and setting the uplink synchronization in each timing alignment group. The representative serving cell may also be called a special serving cell or a reference serving cell. When the timing alignment group configuration information does not include the representative serving cell unlike the above-mentioned exemplary embodiment, the mobile station itself may select the representative serving cell in each timing alignment group.

The mobile station performs the random access procedure on the base station (S925). The mobile station performs the random access procedure on the representative serving cell based on the timing alignment group configuration information. Here, the random access procedure for the secondary serving cell may start through a command of the base station. In this case, the random access procedure may be performed only after the representative serving cell is activated. In other words, the random access procedure for the activated secondary serving cell may be initiated by the PDCCH command transmitted by the base station. Here, the PDCCH command is allocated to a control information region of a secondary serving cell performing the random access procedure and then transmitted. In addition, the PDCCH command may also include an indicator indicating the secondary serving cell. Here, the random access procedure may be basically performed based on non-contention. However, the random access procedure may also be performed based on contention according to the intention of the base station.

Hereinafter, a method for performing uplink synchronization according to handover according to the exemplary embodiment of the present invention will be described.

The mobile station needs to obtain a valid timing alignment value for an UL CC corresponding to a corresponding serving cell in order to transmit an uplink signal other than the random access preamble. When the valid timing alignment value for the UL CC is secured, the mobile station may periodically or aperiodically transmit the uplink signal such as a sounding reference signal (SRS) on the UL CC. The SRS becomes the basis of judging whether the base station updates the timing alignment value. In addition, the base station may confirm whether the timing alignment value secured for the UL CC from the uplink signal is valid or needs to be updated in real time. When it is required to update the timing alignment value, the base station may inform the mobile station of the updated timing alignment value through the MAC control element (CE).

Meanwhile, in the case in which the mobile station changes the primary serving cell into other frequency band in the same base station or changes the primary serving cell into the same or other frequency band in other base station, a handover procedure from a source base station (eNB) (or a first base station) to a target base station (eNB) (or a second base station) is performed. The handover indicates a function in which when the mobile station is out of a current communication service zone to move to a neighboring communication serving zone, it is tuned to a new traffic channel of the neighboring communication serving zone to continuously maintain a call state. The mobile station that is in communication with a specific base station is linked to other neighboring base station by the handover in the case in which signal strength of the specific base station becomes weak. When the handover is performed, a call drop generated at the time of movement to the neighboring cell may be solved.

When the handover is performed, existing secondary serving cells configured by the source base station are not released, but all of the secondary serving cells that are in an activation state becomes a deactivation state. In addition, after the handover is performed, the secondary serving cells of the target base station are in the deactivation state.

However, the uplink signal may be transmitted only in the case in which the UL CC is activated. Conversely speaking, in a state in which the secondary serving cell is deactivated, the mobile station may not transmit the uplink signal through the UL SCC corresponding to the secondary serving cell. Therefore, the base station or the mobile station may not judge validity of an existing set timing alignment value. That is, transmission impossibility of the uplink signal due to the deactivation of the secondary serving cell causes uncertainty of the validity of the timing alignment value. When the deactivated secondary serving cell is activated by an activation indicator in a state in which the validity of the existing set timing alignment value is not decided for a predetermined time, it is required for the mobile station to confirm whether the existing set timing alignment value is valid. The reason is that a subsequence procedure, that is, whether or not the uplink signal may be transmitted, or the like, is changed according to whether the timing alignment value is valid.

Therefore, the mobile station may not transmit the uplink signal through the UL SCC corresponding to the secondary serving cell of the target base station that is in the deactivation state, and the base station and the mobile station may not judge the validity of the existing set timing alignment value. The mobile station may confirm whether the existing set timing alignment value is valid and transmit the uplink signal according to the uplink timing adjusted based on an existing timing alignment value when the timing alignment value is valid.

In order to more rapidly secure the uplink synchronization for the secondary serving cell, a method of securing a timing alignment value in a handover step performed prior to the random access procedure is required.

FIG. 10 is a flow chart showing a method for performing uplink synchronization according to the exemplary embodiment of the present invention. The method shown in FIG. 10 relates to signaling among the mobile station, the source base station, and the target base station that perform the handover.

Referring to FIG. 10, the mobile station transmits a measurement report to the source base station in order to perform the handover prior to the random access procedure (S1000). That is, the measurement report includes quantitative information, for example, RSRP or RSRQ, used for the mobile station to judge a triggering condition of the measurement report. The RSRP may be defined as a signal quality value measured by comparing strength of a desired signal with those of all of the received signals, and the RSRQ may be defined as a signal quality value measured by comparing the strength of the desired signal with those of all of the received signals. The RSRP is calculated as the linear average for power contribution of resource elements. Here, the resource elements carry a cell-specific reference signal in a considered measurement frequency bandwidth. A reference point of the RSRP is an antenna connector of the mobile station. Meanwhile, the RSRQ is defined as a ratio between the RSRP and received signal strength indicator (RSSI) as represented by Equation 2.

$$RSRQ = N \times \frac{RSRP}{RSSI} \qquad [ Equation 2 ]$$

Where N indicates the number of resource elements in a carrier RSSI measurement bandwidth of a wireless access network. A numerator and a denominator in Equation 2 are measured with respect to a set of the same resource blocks. The RSSI includes the linear average of the entire received power. The entire received power is a value that is observed only in an OFDM symbol including reference symbols in the measurement bandwidth and obtained over N resource blocks. The reference symbols may be OFDM symbols in which a cell-specific reference signal (CRS) is present. Alternatively, the reference symbols may be all OFDM symbols in a subframe.

Handover generally is defined in the case that a source base station and a target base station are different devices which are physically separated, but in the present invention, handover may also be defined in the case that source base station and target base station are same base station device which are not physically separated.

As one example, if single base station comprises several serving cells, when a mobile station is about to change the serving cell from one cell to another cell of the base station, the mobile station needs to use handover procedure. In the case that single base station may comprise several serving cells, the single base station may compose of at least two frequency bands which are not overlapped about downlink resources or at least one frequency band about uplink resources.

Also, if a mobile station composes of several component carriers, primary serving cell may be changed through a handover procedure. For example, in the case a mobile station composes frequency bands which are not composed as serving cells as a primary serving cell, or in the case a mobile station composes serving cells which are composed as secondary serving cells as a primary serving cell, handover procedure may be used.

The source base station transmits a handover request message to the target base station based on the measurement result to request the handover (S1005). When the primary serving cell is changed due to the handover procedure, the secondary serving cells are changed into the deactivation state. Particularly, when the base station is changed due to the handover procedure, since the uplink synchronization with the target station needs to be newly set, the case in which the timing alignment value and the timing alignment groups are changed as well as the case in which each secondary serving cell is released may be generated.

In the case in which the primary serving cell is changed into the same or other frequency band in the target base station, the source base station allows RRC configuration information of the mobile station to be included in the handover request message and then transmits the handover request message to the target base station. In this case, the handover request message includes all of measurement information values for the serving cells that the source base station receives from the mobile station and all secondary serving cell configuration information that the source base station configures for the mobile station. The target base station may judge whether or not it releases the secondary serving cells configured by the source base station based on the RRC configuration information and situations of the target base station (for example, a data traffic loading situation, a supportable frequency band, a supportable 3GPP release version, or the like).

The target base station transmits a handover admission message to the source base station to admit the handover (S1010). The mobile station deactivates all of the secondary serving cells at the time of performing the handover to the target base station. The handover admission message includes timing alignment related information on secondary serving cells selected by the target base station among all of the deactivated secondary serving cells, such as timing alignment group information, random access preamble information, and PRACH mask index information. The random access preamble and the PRACH mask index have been described in the above Tables 1 and 2. The TAG which is one of timing alignment related information may be reconfigured at any time according to mobility of the mobile station, or the like. TAG which is one of timing alignment related information may be realigned frequently by mobility of a mobile station, etc.

The timing alignment related information to be applied to the secondary serving cell of the target base station is transferred to the mobile station in advance in the handover procedure, such that the mobile station may rapidly activate the secondary serving cell for the uplink synchronization in the random access procedure.

As an example, in the case in which the source base station and the target base station are physically the same as each other (that is, in the case of the same base station in the same network), after the mobile station recognizes information on the secondary serving cells, the mobile station does not release the secondary serving cells after the handover, such that it is may rapidly activate the secondary serving cell for the uplink synchronization.

Next to step (S1010), the source base station commands the mobile station to perform the handover (S1015). The handover command is transmitted through a handover command message. The handover command message includes the timing alignment related information (for example, the timing alignment group information, the random access preamble information, and the PRACH mask index information) on the secondary serving cells in the deactivation state that the source base station receives through the handover admission message. Here, the random access preamble information and the PRACH mask index information may be included in mobility control information (MCI) of the handover command message. In the case in which the target base station recognizes cells capable of sharing the timing alignment values of each serving cell with each other in advance or may judge the cells based on information provided from the source base station, information on the timing alignment group may also be included in the MCI.

The following Table 4 shows an example of MCI including the random access preamble information and the PRACH mask index information.

TABLE 4

| | |
|---|---|
| RACH-ConfigDedicated ::= | SEQUENCE { |

| | |
|---|---|
| ra-PreambleIndex | INTEGER (0..63), |
| ra-PRACH-MaskIndex | INTEGER (0..15) |
| } | |

| | |
|---|---|
| RACH-ConfigDedicated-SCellList ::= | SEQUENCE (SIZE (1..7)) |

OF RACH-ConfigDedicated-SCell-r11

| | |
|---|---|
| RACH-ConfigDedicated-SCell-r11 ::= | SEQUENCE { |

| | |
|---|---|
| Serv-index | INTEGER (1..7), |
| ra-PreambleIndex | INTEGER (0..63), |
| ra-PRACH-MaskIndex | INTEGER (0..15) |
| } | |

Referring to Table 4, RACH-ConfigDedicated indicates non-contention random access configuration information on PCell, ra-PreambleIndex indicates a random access preamble index value, ra-PRACH-MaskIndex indicates a PRACH mask index, RACH-ConfigDedicated-SCell-r11 indicates non-contention random access configuration information on SCell, and Serv-index indicates a serving cell index.

The mobile station that has received the handover command message performs a random access procedure through the primary serving cell (S1020). The random access procedure includes a procedure in which the mobile station performs the handover to the target base station. As the random access procedure, the contention based random access procedure or the non-contention based random access procedure described above with reference to FIGS. 6 and 7 may be performed. In addition, the random access procedure in which the timing alignment group is applied as described with reference to FIG. 9 may be performed.

When the random access procedure through the primary serving cell is successfully completed, the target base station transmits secondary serving cell activation/deactivation indication information to the mobile station through the MAC control element (MAC CE). The mobile station receiving the secondary serving cell activation/deactivation indication information activates required secondary serving cells among the deactivated secondary serving cells (S1025).

The activated secondary serving cells first perform only an activation operation for a downlink component carrier in a predetermined activation timing. As an example, when the secondary serving cell activation/deactivation indication information is received in the n-th subframe, the activated secondary serving cells first perform only the activation operation for the downlink component carrier in the n+8th subframe.

Then, the mobile station performs a random access procedure through the secondary serving cells that have started the downlink activation operation (S1030). Here, the random access procedure of the secondary serving cell may be performed by the mobile station using the previously received timing alignment related information such as the random access preamble, the PRACH mask index information, and the like.

In order to start the activation operation of the uplink component carrier in the secondary serving cell, the mobile station first adjusts the uplink timings based on the timing alignment value secured through the random access procedure. As an example, the mobile station may calculate timing (TA) to be adjusted using the timing alignment value (N_{TA}) provided by the base station and adjust the uplink timing. As another example, the adjusted timing (TA) may be calculated by the timing alignment value regarding the secondary serving cell calculated based on the timing alignment value regarding the primary serving cell. Then, the mobile station performs an uplink activation operation in the secondary serving cell in the adjusted uplink timing. For example, the mobile station initiates the operation of the deactivation timer regarding the secondary serving cell, performs the monitoring of the PDCCH for the control region of the secondary serving cell with respect to the DL SCC corresponding to the secondary serving cell, or processes the downlink and uplink resource allocation for the secondary serving cell. Alternatively, the mobile station performs transmission of the uplink signal. For example, the mobile station performs the transmission of the periodic SRS or the aperiodic SRS with respect to the UL SCC corresponding to the secondary serving cell or performs the reporting of the channel quality information. Alternatively, the mobile station performs transmission or retransmission of the PUSCH.

Similar to the random access procedure through the primary serving cell, the random access procedure through the secondary serving cell includes a procedure in which the mobile station performs the handover to the target base station. As the random access procedure, the contention based random access procedure or the non-contention based random access procedure described above with reference to FIGS. 6 and 7 or the random access procedure in which the timing alignment group is applied as described with reference to FIG. 9 may be performed.

Then, RRC connection is reconfigured (S1035). The secondary serving cell is added, released, or modified.

FIG. 11 is a flow chart showing a method for performing uplink synchronization according to another exemplary embodiment of the present invention. The method shown in FIG. 11 relates to signaling between the mobile station, the source base station, and the target base station in the case in which the target base station may not provide or is not intended to provide RACH information to the secondary serving cell of the mobile station (for example, in the case in which an available PRACH resource (or random access preamble) for the non-contention based random access procedure is not present). In this case, the target base station does not inform the mobile station of the timing alignment related information (for example, the random access preamble and the PRACH mask index) in advance before the handover procedure. Instead, the mobile station separately performs a procedure for obtaining a timing alignment value for the secondary serving cell after the handover procedure.

Referring to FIG. 11, for the sake of handover, the mobile station transmits a measurement result to the source base station (S1100), the source base station transmits a handover request message to the target base station based on the measurement result to request the handover (S1105), and the target base station transmits a handover admission message to the source base station to admit the handover (S1110). The source base station transmits a handover command message to the mobile station to command the handover (S1115). However, the handover admission message and the handover command message do not include information on whether or not the secondary serving cells configured by the source base station are released and do not also include the timing alignment group information, the random access preamble information, and the PRACH mask index information on the secondary serving cells in the deactivated state.

The mobile station that has received the handover command message performs the random access procedure through the primary serving cell (S1120). In this process, the mobile station performs the handover to the target base station or the primary serving cell. The timing alignment group may be set after the handover procedure is performed.

Then, RRC connection is reconfigured (S1125). The secondary serving cell may be added, released, or modified. In the case in which the timing alignment group may not be set through the previously secured information in a network, the timing alignment group may be set after assistant information (for example, position information, RSRP, RSRQ, or the like) is received from the mobile station.

In the case in which all information required for setting the timing alignment group is not secured even using the assistant information, the target base station may command the secondary serving cells required for setting the timing alignment group to activate (or deactivate) the MAC control element (S1130) and then perform the PDCCH order with respect to the activated secondary serving cell (S1135), and the mobile station may perform the random access procedure through the activated secondary serving cell (S1140). After the random access procedure is completed, the timing alignment group information may be transmitted to the mobile station through an RRC connection reconfiguration procedure.

The following Table 5 is a table showing an example of an RRC connection reconfiguration message including the timing alignment group information in the RRC connection reconfiguration procedure. Table 5 corresponds to the case in which the number of timing alignment groups is 2.

TABLE 5

| | |
|---|---|
| TAG-ConfigDedicated ::= | SEQUENCE { |

| | |
|---|---|
| pTAG | SCellListOfTAG, |
| sTAG | SCellListOfTAG, |
| sTAG-referenceCell | INTEGER (1..7) |
| } | |

| | |
|---|---|
| SCellListOfTAG ::= | SEQUENCE (SIZE (1..7)) OF Serv-index |

The following Table 6 is a table showing another example of an RRC connection reconfiguration message including the timing alignment group information in the RRC connection reconfiguration procedure. Table 6 corresponds to the case in which the number of timing alignment groups is 2.

TABLE 6

| | |
|---|---|
| TAG-ConfigDedicated ::= | SEQUENCE { |

| | |
|---|---|
| pTAG | BIT STRING (SIZE (7)), |
| sTAG | BIT STRING (SIZE (7)), |
| sTAG-referenceCell | INTEGER (1..7) |
| } | |

The timing alignment group information may also be transmitted to the mobile station through the MAC control element or be transmitted in a form of the MAC message, after the random access procedure is completed.

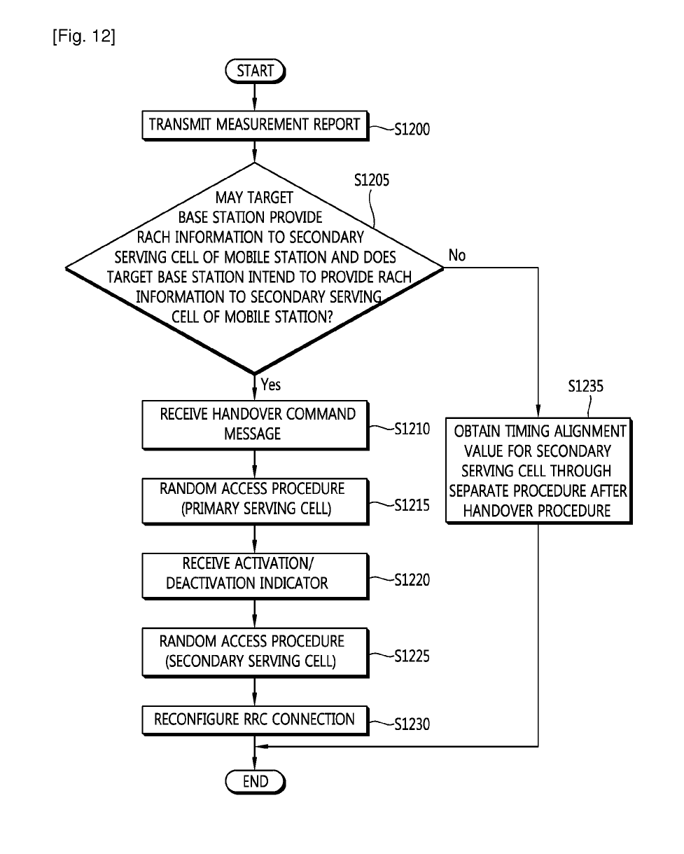

FIG. 12 is a flow chart showing a method for performing uplink synchronization of a mobile station according to the exemplary embodiment of the present invention.

Referring to FIG. 12, the mobile station transmits a measurement report to the source base station in order to perform the handover before the random access procedure (S1200).

In the case in which the target base station may provide or is intended to provide the RACH information to the secondary serving cell of the mobile station (S1205), the mobile station receives a handover command message from the source base station receiving handover admission from the target base station (S1210). The handover request message includes all of measurement information values for the serving cells that the source base station receives from the mobile station and all secondary serving cell configuration information that the source base station configures for the mobile station. In addition, the handover command message includes the timing alignment related information (for example, the timing alignment group information, the random access preamble information, and the PRACH mask index information) on the secondary serving cells in the deactivation state that the source base station receives from the target base station through the handover admission message. Here, the random access preamble information and the PRACH mask index information may be included in the MCI of the handover command message. In the case in which the target base station recognizes cells capable of sharing the timing alignment values of each serving cell with each other in advance or may judge the cells based on information provided from the source base station, information on the timing alignment group may also be included in the MCI.

The mobile station that has received the handover command message performs the random access procedure through the primary serving cell (S1215). When the random access procedure for the primary serving cell is completed, the mobile station receives a secondary serving cell activation/deactivation indicator from the base station (S1220). The mobile station receiving the secondary serving cell activation/deactivation indication information activates required secondary serving cells among the deactivated secondary serving cells.

The mobile station performs the random access procedure through the activated secondary serving cell (S1225). As the random access procedure through the secondary serving cell, the contention based random access procedure or the non-contention based random access procedure described above with reference to FIGS. 6 and 7 may be performed. In addition, the random access procedure in which the timing alignment group is applied as described with reference to FIG. 9 may be performed. Then, the mobile station reconfigures RRC connection with the target base station (S1230).

Meanwhile, in the case in which the target base station may not provide or is not intended to provide the RACH information to the secondary serving cell of the mobile station, the mobile station performs the procedure for obtaining a timing alignment value for the secondary serving cell after the handover procedure, through a separate procedure such as the RRC connection reconfiguration procedure (S1235).

Here, the mobile station does not receive the timing alignment related information (for example, the random access preamble and the PRACH mask index) in advance before the handover procedure, and also sets the timing alignment group after the handover procedure is performed. In a subsequent RRC connection reconfiguration step, in the case in which the timing alignment group may not be set through the previously secured information in a network, the timing alignment group may be set after assistant information (for example, position information, RSRP, RSRQ, or the like) is received from the mobile station. In the case in which all information required for setting the timing alignment group is not secured even using the assistant information, the target base station may command the secondary serving cells required for setting the timing alignment group to be activated and command the PDCCH with respect to the activated secondary serving cell, and the mobile station may perform the random access procedure through the activated secondary serving cell. After the random access procedure is completed, the mobile station may receive the timing alignment group information from the target base station through the RRC connection reconfiguration procedure.

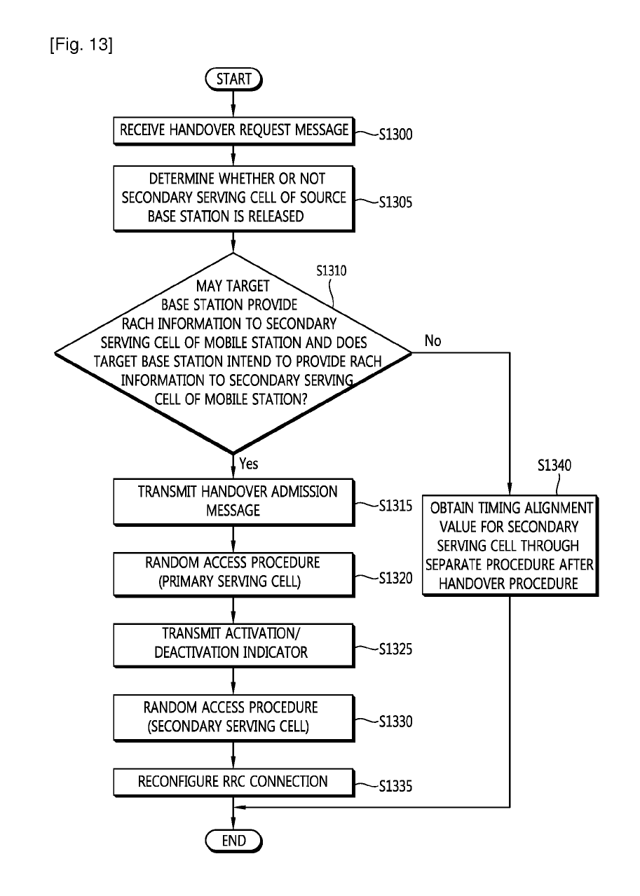

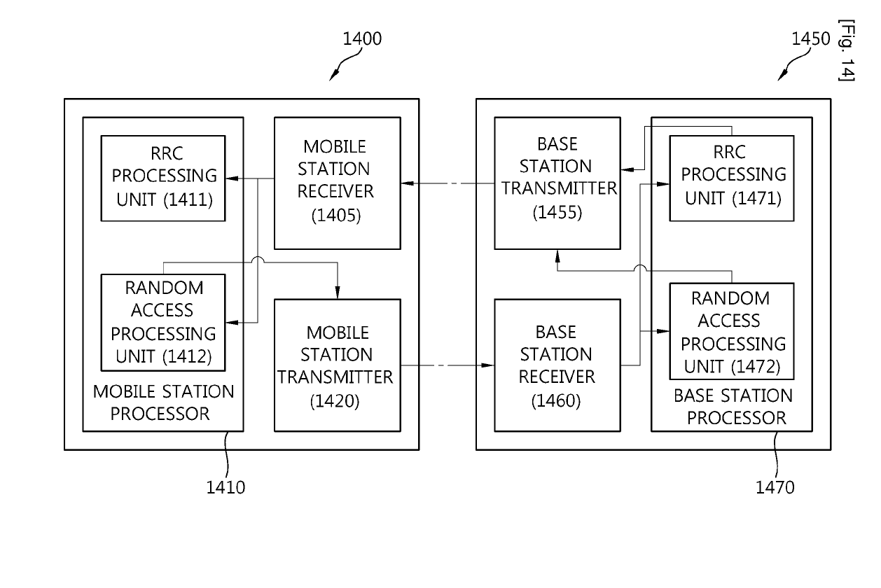

FIG. 13 is a flow chart showing a method for performing uplink synchronization of a base station according to the exemplary embodiment of the present invention. FIG. 13 shows an operation of the target base station for the handover performed by the mobile station.

Referring to FIG. 13, the target base station receives a handover request message transmitted by the source base station based on a measurement result of the mobile station (S1300). In the case in which the primary serving cell is changed into the same or other frequency band in the target base station, the handover request message may include all of RCC configuration information of the mobile station, measurement information values for the serving cells that the source base station receives from the mobile station, and all secondary serving cell configuration information that the source base station configures for the mobile station.

The target base station judges whether or not it releases the secondary serving cells configured by the source base station based on the RRC configuration information and situations of the target base station (for example, a data traffic loading situation, a supportable frequency band, a supportable 3GPP release version, or the like) (S1305).

In the case in which the target base station may provide or is intended to provide the RACH information to the secondary serving cell of the mobile station (S1310), the target base station transmits a handover admission message to the source base station to admit the handover (S1315). When the mobile station performs the handover to the target base station, all of the secondary serving cells are deactivated. In addition, the handover admission message may include the timing alignment related information on the secondary serving cells in the deactivated state, such as the timing alignment group information, the random access preamble information, and the PRACH mask index. The random access preamble and the PRACH mask index have been described in the above Tables 1 and 2.

A random access procedure with the mobile station is performed through the primary serving cell (S1320). The random access procedure includes a procedure in which the mobile station performs the handover to the target base station. As the random access procedure, the contention based random access procedure or the non-contention based random access procedure described above with reference to FIGS. 6 and 7 may be performed. In addition, the random access procedure in which the timing alignment group is applied as described with reference to FIG. 9 may be performed.

Then, in the case in which the random access procedure through the primary serving cell is successfully completed, the target base station transmits secondary serving cell activation/deactivation indication information to the mobile station through the MAC control element (MAC CE) (S1325) to command the mobile station receiving the secondary serving cell activation/deactivation indication information to activate required secondary serving cells among the deactivated secondary serving cells.

Then, when the secondary serving cells are activated by the mobile station using the previously received timing alignment related information such as the random access preamble, the PRACH mask index information, and the like, the random access procedure with the mobile station is performed (S1330). Then, RRC connection is reconfigured (S1335).

Meanwhile, in the case in which the target base station may not provide or is not intended to provide the RACH information to the secondary serving cell of the mobile station, the target base station does not inform the mobile station of the timing alignment related information (for example, the random access preamble and the PRACH mask index) in advance before the handover procedure, but the mobile station separately performs a procedure for obtaining a timing alignment value for the secondary serving cell after the handover procedure (S1340). The handover admission message does not include information on whether or not the secondary serving cells configured by the source base station are released and does not also include the timing alignment group information, the random access preamble information, and the PRACH mask index information on the secondary serving cells in the deactivated state.

The target base station performs the random access procedure with the mobile station through the primary serving cell and reconfigures the RRC connection. In the case in which the timing alignment group may not be set through the previously secured information in a network, the timing alignment group may be set after the assistant information is received from the mobile station. In the case in which all information required for setting the timing alignment group is not secured even using the assistant information, the target base station may command the secondary serving cells required for setting the timing alignment group to be activated, command the PDCCH with respect to the activated secondary serving cell, and perform the random access procedure with the mobile station through the activated secondary serving cell. After the random access procedure is completed, the timing alignment group information may be transmitted to the mobile station through an RRC connection reconfiguration procedure.

FIG. 14 is a block diagram showing the base station and the mobile station performing the uplink synchronization according to the exemplary embodiment of the present invention. Here, the base station means the target base station to which the mobile station performs the handover.

Referring to FIG. 14, the mobile station 1400 includes a mobile station receiver 1405, a mobile station processor 1410, and a mobile station transmitter 1420. The mobile station processor 1410 includes an RRC processing unit 1411 and a random access processing unit 1412.

The mobile station transmitter 1420 transmits a measurement report to the source base station. The measurement report includes quantitative information, for example, RSRP or RSRQ used for the mobile station to judge a triggering condition of the measurement report.

The mobile station receiver 1405 receives a handover command message from the source base station. The handover command message includes the timing alignment related information (for example, the timing alignment group information, the random access preamble information, and the PRACH mask index information) on the secondary serving cells in the deactivation state that the source base station receives through the handover admission message. Here, the random access preamble information and the PRACH mask index information may be included in the MCI of the handover command message. In the case in which the target base station recognizes cells capable of sharing the timing alignment values of each serving cell with each other in advance or may judge the cells based on information provided from the source base station, information on the timing alignment group may also be included in the MCI. See the above Table 4 with respect to the MCI including the random access preamble information and the PARCH mask index information.

The random access processing unit 1412 performs a random access procedure through the primary serving cell. The random access procedure includes a procedure in which the mobile station performs the handover to the target base station. As the random access procedure, the contention based random access procedure or the non-contention based random access procedure described above with reference to FIGS. 6 and 7 may be performed. In addition, the random access procedure in which the timing alignment group is applied as described with reference to FIG. 9 may be performed.

In addition, the random access processing unit 1412 performs the random access procedure through an activated serving cell. Here, the activation of the secondary serving cell is performed by the mobile station using the previously received timing alignment related information such as the random access preamble, the PRACH mask index information, and the like. In order to activate the secondary serving cell, the random access processing unit first adjusts uplink timing based on a timing alignment value. As an example, the mobile station may calculate timing (TA) to be adjusted using the timing alignment value (N_{TA}) provided by the base station and adjust the uplink timing. As another example, the adjusted timing (TA) may be calculated by the timing alignment value regarding the secondary serving cell calculated based on the timing alignment value regarding the primary serving cell.

In addition, the random access processing unit 1412 of the mobile station performs an uplink activation operation in the secondary serving cell based on the adjusted uplink timing. For example, the mobile station initiates the operation of the deactivation timer regarding the secondary serving cell, performs the monitoring of the PDCCH for the control region of the secondary serving cell with respect to the DL SCC corresponding to the secondary serving cell, or processes the downlink and uplink resource allocation for the secondary serving cell. Alternatively, the mobile station performs transmission of the uplink signal. For example, the mobile station performs the transmission of the periodic SRS or the aperiodic SRS with respect to the UL SCC corresponding to the secondary serving cell or performs the reporting of the channel quality information. Alternatively, the mobile station performs transmission or retransmission of the PUSCH.

The RRC processing unit 1411 reconfigures RRC connection. The RRC processing unit adds, releases, or modifies the secondary serving cell.

The base station 1450 includes a base station transmitter 1455, a base station receiver 1460, and a base station processor 1470. The base station processor 1470 also includes an RRC processing unit 1471 and a random access processing unit 1472.

The base station receiver 1460 receives a handover request message from the source base station. When the primary serving cell is changed due to the handover procedure, the secondary serving cells are changed into the deactivation state. Particularly, when the base station is changed due to the handover procedure, since the uplink synchronization with the target station needs to be newly set, the case in which the timing alignment value and the timing alignment groups are changed as well as the case in which each secondary serving cell is released may be generated. In the case in which the primary serving cell is changed into the same or other frequency band in the target base station, the handover request message includes all of RCC configuration information of the mobile station, measurement information values for the serving cells that the source base station receives from the mobile station, and all secondary serving cell configuration information that the source base station configures for the mobile station.

The base station transmitter 1455 receives a handover admission message from the source base station. The handover admission message includes information on whether the secondary serving cells configured by the source base station are released. In addition, the handover admission message includes the timing alignment related information on the secondary serving cells in the deactivated state, such as the timing alignment group information, the random access preamble information, and the PRACH mask index information. The random access preamble and the PRACH mask index have been described in the above Tables 1 and 2.

The random access processing unit 1472 judges whether or not it releases the secondary serving cells configured by the source base station based on the RRC configuration information and situations of the target base station (for example, a data traffic loading situation, a supportable frequency band, a supportable 3GPP release version, or the like).

In addition, the random access processing unit 1472 performs a random access procedure with the mobile station through the primary serving cell. The random access procedure includes a procedure in which the mobile station performs the handover to the target base station. As the random access procedure, the contention based random access procedure or the non-contention based random access procedure described above with reference to FIGS. 6 and 7 may be performed. In addition, the random access procedure in which the timing alignment group is applied as described with reference to FIG. 9 may be performed.

In addition, the random access processing unit 1472 activates (or deactivates) an MAC control element.

In addition, the random access processing unit 1472 performs the random access procedure with the mobile station through an activated secondary serving cell. Here, the activation of the secondary serving cell is performed by the mobile station using the previously received timing alignment related information such as the random access preamble, the PRACH mask index information, and the like.

The RRC processing unit 1471 reconfigures RRC connection. The RRC processing unit adds, releases, or modifies the secondary serving cell.

The spirit of the present invention has been just exemplified. It will be appreciated by those skilled in the art that various modifications and alterations can be made without departing from the essential characteristics of the present invention. Accordingly, the embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

1. A method for performing uplink synchronization by a mobile station, the method comprising:
receiving a handover command message from a first base station, the handover command message including a timing alignment value for adjusting uplink timing of a secondary serving cell of a second base station;
performing handover from the first base station to the second base station based on the handover command message;
adjusting the uplink timing of the secondary serving cell of the second base station based on the timing alignment value; and
performing a random access through the secondary serving cell of the second base station based on the adjusted uplink timing,
wherein the handover command message includes a preamble index indicating a preamble selected among dedicated random access preambles reserved in advance for a non-contention based random access procedure and a physical random access channel (PRACH) mask index indicating available time or frequency resource information.

2. The method of claim 1, further comprising:
after the performing of the random access, receiving a radio resource control (RRC) reconfiguration message from the second base station, the RRC reconfiguration message including timing alignment group information on serving cells to which the same timing alignment value is applied among serving cells in a timing alignment group including at least one serving cell.

3. The method of claim 2, wherein the timing alignment group information includes a list configured of cell indices of the serving cells to which the same timing alignment value is applied.

4. The method of claim 1, wherein the preamble index and the PRACH mask index are included in mobility control information (MCI) in the handover command message.

5. The method of claim 1, wherein the preamble index and the PRACH mask index are included in downlink control information (DCI) for allocating downlink resources.

6. The method of claim 1, wherein the first base station and the second base station are physically same base station but compose of different serving cells each other.

7. The method of claim 1, wherein the handover is performed when the mobile station composing of multiple component carriers changes a primary serving cell to one of frequency bands which are not composed as serving cells or a serving cell which is composed as a secondary serving cell.

8. A method for performing uplink synchronization by a first base station, the method comprising:
receiving a handover request message from a second base station, the handover request message including a radio resource control (RRC) configuration information of a mobile station and secondary serving cell configuration information of the mobile station;
transmitting a handover admission message to the second base station, the handover admission message including information on whether or not secondary serving cells configured by the second base station are released and a timing alignment value for adjusting uplink timing of a secondary serving cell of the first base station; and
performing a random access with the mobile station through the secondary serving cell of the first base station based on the uplink timing of the secondary serving cell of the first base station adjusted based on the timing alignment value,
wherein the handover admission message includes a preamble index indicating a preamble selected among dedicated random access preambles reserved in advance for a non-contention based random access procedure and a physical random access channel (PRACH) mask index indicating available time or frequency resource information.

9. The method of claim 8, further comprising:
after the receiving of the handover request message, judging whether or not secondary serving cells configured by the second base station are released based on the RRC configuration information of the mobile station and a data traffic loading situation, a supportable frequency band, or a supportable release version of the base station.

10. The method of claim 8, further comprising:
after the performing of the random access, transmitting an RRC reconfiguration message to the mobile station, the RRC reconfiguration message including timing alignment group information on serving cells to which the same timing alignment value is applied among serving cells in a timing alignment group including at least one serving cell.

11. The method of claim 8, wherein the preamble index and the PRACH mask index are included in mobile control information (MCI) in the handover command message.

12. The method of claim 8, wherein the preamble index and the PRACH mask index are included in downlink control information (DCI) for allocating downlink resources.

13. The method of claim 8, wherein the first base station and the second base station are physically same base station but compose of different serving cells each other.

14. The method of claim 8, wherein the handover request message or the handover admission message is transmitted when the mobile station composing of multiple component carriers changes a primary serving cell to one of frequency bands which are not composed as serving cells or a serving cell which is composed as a secondary serving cell.

15. A mobile station to perform uplink synchronization, the mobile station comprising:
a mobile station receiver to receive a handover command message from a first base station, the handover command message including a timing alignment value for adjusting uplink timing of a secondary serving cell of a second base station; and
a random access processing unit to perform handover from the first base station to the second base station based on the handover command message, to adjust the uplink timing of the secondary serving cell of the second base station based on the timing alignment value, and to perform a random access through the secondary serving cell of the second base station based on the adjusted uplink timing,
wherein the handover command message includes a preamble index indicating a preamble selected among dedicated random access preambles reserved in advance for a non-contention based random access procedure and a physical random access channel (PRACH) mask index indicating available time or frequency resource information.

16. The mobile station of claim 15, wherein the mobile station receiver receives a radio resource control (RRC) reconfiguration message from the second base station after the random access is performed, the RRC reconfiguration message including timing alignment group information on serving cells to which the same timing alignment value is applied among serving cells in a timing alignment group including at least one serving cell.

17. The mobile station of claim 16, wherein the timing alignment group information includes a list configured of cell indices of the serving cells to which the same timing alignment value is applied.

18. The mobile station of claim 15, wherein the preamble index and the PRACH mask index are included in mobility control information (MCI) in the handover command message.

19. A base station to perform uplink synchronization, the base station comprising:
a base station receiver to receive a handover request message from a second base station, the handover request message including radio resource control (RRC) configuration information of a mobile station and secondary serving cell configuration information of the mobile station;
a base station transmitter to transmit a handover admission message to the second base station, the handover admission message including information on whether or not secondary serving cells configured by the second base station are released and a timing alignment value for adjusting uplink timing of a secondary serving cell of the base station; and
a random access processing unit to perform a random access with the mobile station through the secondary serving cell of the base station based on the uplink timing of the secondary serving cell of the first base station adjusted based on the timing alignment value,
wherein the handover admission message includes a preamble index indicating a preamble selected among dedicated random access preambles reserved in advance for a non-contention based random access procedure and a physical random access channel (PRACH) mask index indicating available time or frequency resource information.
